(19) United States
(12) Patent Application Publication
(10) Pub. No.: US 2026/0064580 A1
(43) Pub. Date: Mar. 5, 2026

(54) STANDARDIZING A SERVICE FRAMEWORK ASSOCIATED WITH A FLASH TRANSLATION LAYER

(71) Applicant: Micron Technology, Inc., Boise, ID (US)

(72) Inventors: Ying Huang, Boise, ID (US); Jonathan Condel, Boise, ID (US)

(21) Appl. No.: 18/816,203

(22) Filed: Aug. 27, 2024

(51) Int. Cl. G06F 12/02

(52) U.S. Cl. CPC G06F 12/0246

(57) ABSTRACT

A processing device includes a plurality of cores coupled to a memory device that stores data. The cores execute a plurality of service applications that implement at least a portion of a flash translation layer (FTL) to direct operations to be performed by the memory device with reference to the data while tracking translations between a logical block address space to a physical address space. The cores also execute an FTL service framework that includes a plurality of application programming interfaces (APIs), wherein the plurality of APIs are configured to standardize communication between the plurality of service applications across the plurality of cores during runtime operation of the plurality of cores.

### TECHNICAL FIELD

Embodiments of the disclosure relate generally to memory sub-systems, and more specifically, to standardizing a service framework associated with a flash translation layer.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1A illustrates an example computing system that includes a memory sub-system in accordance with some embodiments.

FIG. 1B illustrates a plurality of cores of the memory sub-system controller implementing a plurality of service applications and a flash translation layer (FTL) service framework according to some embodiments.

FIG. 2 is a block diagram depiction of a write sequencer arrangement of multiple dies and block stripes according to various embodiments.

FIG. 3 is a graph depiction of a write sequencer arrangement of multiple dies and an example logical-to-physical (P2L) address range across planes of the multiple dies that might make up different write commands according to various embodiments.

FIG. 4 is an example sub-system controller that includes a write service manager and other supporting components for backend command generation and related P2L/L2P tracking according to some embodiments.

FIG. 5 is a flow diagram of an example method of employing an FTL service framework that standardizes communication between a plurality of service application according to some embodiments.

FIG. 6A is a flow diagram of an example method of creating and registering service applications according to various embodiments.

FIG. 6B is a flow diagram of an example method of managing execution of service applications according to various embodiments.

FIG. 7 is a flow diagram of an example method representing common state logic for each FTL service application according to some embodiments.

FIG. 8 is a flow diagram of an example method of registering and initializing the service states according to some embodiments.

FIG. 9A is a flow diagram of an example method for a service suspend flow according to some embodiments.

FIG. 9B is a flow diagram of an example method for a service activate flow according to some embodiments.

FIG. 9C is a flow diagram of an example method for a service reset flow according to some embodiments.

FIG. 9D is a flow diagram of an example method for a service synchronization flow according to some embodiments.

FIG. 10 is a flow diagram of an example method of service proxy registration and a service request transmission flow according to some embodiments.

FIG. 11 is a flow diagram of an example method of drive frame reset (DFR) flow across a plurality of cores according to some embodiments.

FIG. 12 is an operation block diagram illustrating service priority control of a plurality of service applications according to some embodiments.

FIG. 13 is a block diagram of an example computer system in which embodiments of the present disclosure can operate.

### DETAILED DESCRIPTION

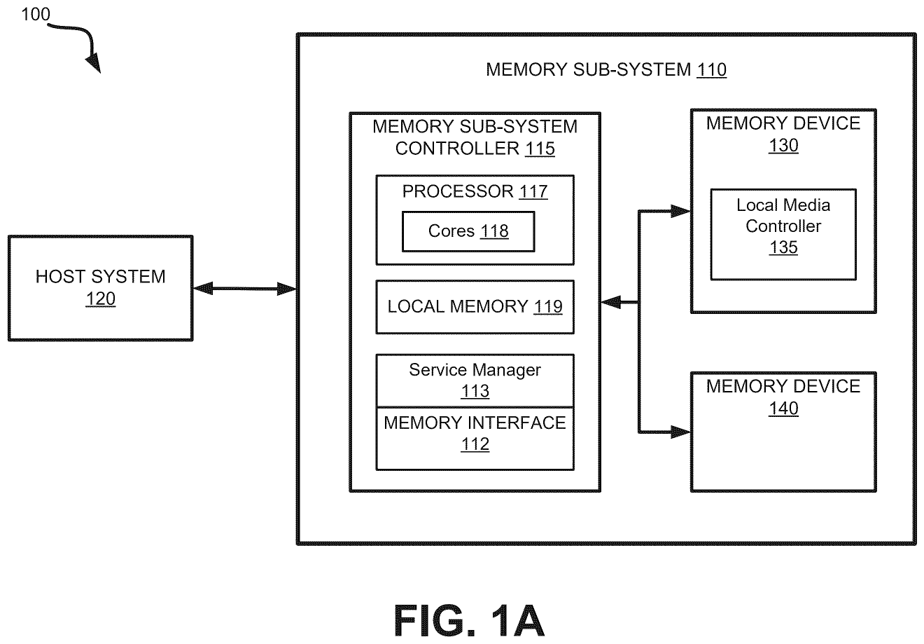

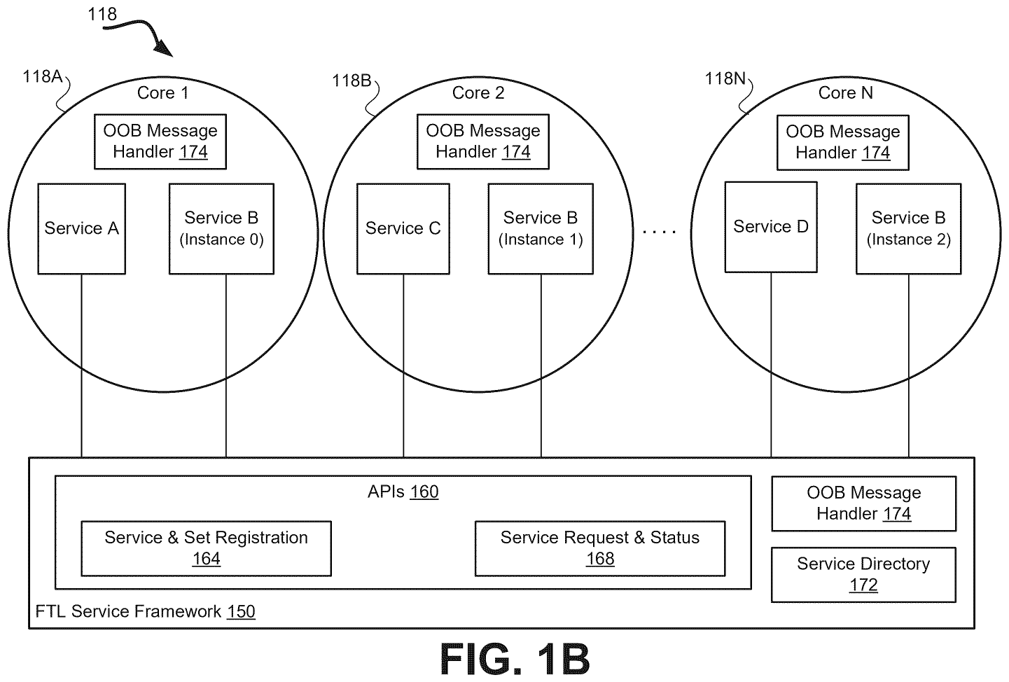

Aspects of the present disclosure are directed to standardizing a service framework associated with a flash translation layer according to some embodiments. A memory sub-system can be a storage device, a memory module, or a combination of a storage device and memory module. Examples of storage devices and memory modules are described below in conjunction with FIG. 1A. In general, a host system can utilize a memory sub-system that includes one or more components, such as memory devices that store data. The host system can provide data to be stored at the memory sub-system and request data to be retrieved from the memory sub-system.

A memory sub-system can include high-density, non-volatile memory devices where retention of data is desired when no power is supplied to the memory device. For example, NAND memory, such as 3D flash NAND memory, offers storage in the form of compact, high-density configurations. A non-volatile memory device is a package of one or more memory dies, each including one or more planes. For some types of non-volatile memory devices (e.g., NAND devices), each plane includes a set of physical blocks. Each block includes a set of pages. Each page includes a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1,” or combinations of such values.

A memory device can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A data block hereinafter refers to a unit of the memory device used to store data and can include a group of memory cells, a wordline group, a wordline, or individual memory cells. When data is written to NAND memory, the data can be written in block stripes that define program lines that are arrayed across different planes of multiple dies of a NAND memory device. In this way, more data can be written at the same time to the memory device due to being spread out across multiple planes and dies.

A flash translation layer (FTL) logic can be employed by a memory sub-system controller (e.g., processing device or “controller”) that sits between the host file system and the NAND flash memory. This FTL logic emulates a traditional block storage device, such as a hard drive, allowing the host file system to interact with the NAND memory without needing to know the details of the underlying hardware of the NAND memory. A mapping management module of the FTL logic can be employed to maintain a mapping table (or other data structure) that translates logical block addresses (LBAs) from the host into physical block addresses (PBAs) in the NAND memory. This mapping can change based on new host writes that cause re-written logical block address (LBA) to be mapped to a different physical NAND location. Other functions that the FTL logic performs can include, for example, wear leveling, garage collection, bad block management, error correction, and data management. The FTL logic can generate backend commands directing the NAND memory to perform write, read, and erase operations, along with other media-management-related operations.

In various memory sub-system controllers that control such memory operations (e.g., write, read, erase, and the like) at memory devices, the FTL logic is distributed across a plurality of processor cores (or just “cores” for simplicity) and other hardware. At least a portion the FTL logic can be implemented as service applications that perform different functionalities, which can be based on specific data path. For example, different write service applications can be configured according to different data paths, such a host data path (e.g., handling writes from the host system 120), a folding write data path (e.g., handling write requests for moving data from one block stripe to another to reclaim free space, which can be performed as part of garbage collection), a flash data manager (FDM) data path (e.g., handling write messages coming from a write service manager 413 or other FTL components), or a post-persist physical-to-logical drop recovery data path (e.g., handling flushing and recovery of in-flight data at APL/CPD).

In certain controllers, only a main processing thread (e.g., first tier code) can be executed on a core to run registered tasks. This main processing thread may only execute service applications associated with a specific data path. If there are additional services to execute or specific updates to the service applications already being executed (e.g., associated with the specific data path), then firmware running on that core has to be redesigned. For example, second-tier services and tasks have to be designed in separately, e.g., as calls to be executed outside of the first tier code. As a result, new generations of controllers or updates to those controllers require significant redesign work from a firmware perspective. This is particularly the case even if service applications are to be implemented by different cores in a different FTL architecture, e.g., adapting the firmware to execute on a different application-specific integrated circuit (ASIC).

Aspects of the present disclosure address the above and other deficiencies by modularizing design of service applications so that each top-level service application has a consistent design regardless of a running mode or data path associated with each service application. This means that service applications can be expected to function the same regardless of core placement, which can include being implemented within completely different ASIC designs, e.g., becoming a part of what will be referred to herein as common FTL (CFTL). For example, developers can reuse firmware modules for CFTL service applications for different FTL design architectures and only need to re-design application-specific FTL (e.g., non-CFTL). The disclosed design architecture endeavors to minimize such non-CFTL portions and relegate these portions lower-level FTL modules that vary by application.

Further, the processing device, system, and methods disclosed herein can be implemented with an FTL service architecture employing a plurality of application programing interfaces (APIs) configured to standardize communication between the plurality of service applications across the plurality of cores during runtime operation of the cores. Thus, in some embodiments, a plurality of service applications and the FTL service framework are configured to be being implemented, without modification, on a different plurality of cores implementing a different FTL design architecture.

Advantages of the present disclosure include providing a modularized service application design for top-level FTL design that can be considered common FTL and thus reusable across FTL design architecture or regardless of shifting service applications to different cores or different-placed cores, which can be caused by firmware design changes for different solid-state device (SSD) products. To facilitate this CFTL-based design, the APIs of the FTL service framework facilitate standardized communication regardless of changes to underlying cores, hardware, data paths, processing threads, and the like of the underlying cores. These and other advantages will be apparent based on the additional details provided herein.

FIG. 1A illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1A illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1A illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include not- and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device 130 having control logic (e.g., local controller 135) on the die and a controller (e.g., memory sub-system controller 115) for media management within the same memory device package. An example of a managed memory device is a managed NAND (MNAND) device. Memory device 130, for example, can represent a single die having some control logic (e.g., local media controller 135) embodied thereon. In some embodiments, one or more components of memory sub-system 110 can be omitted.

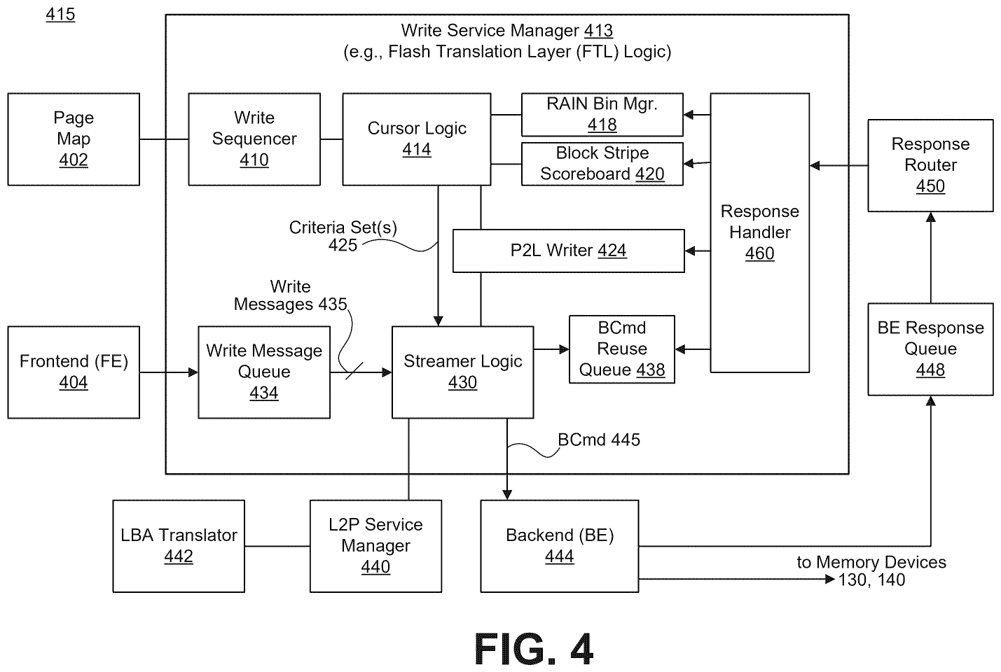

In one embodiment, the memory sub-system 110 includes a memory interface component 112. Memory interface component 112 is responsible for handling interactions of memory sub-system controller 115 with the memory devices of memory sub-system 110, such as memory device 130. For example, memory interface component 112 can send memory access commands corresponding to requests received from host system 120 to memory device 130, such as program commands, read commands, or other commands. In addition, memory interface component 112 can receive data from memory device 130, such as data retrieved in response to a read command or a confirmation that a program command was successfully performed. In embodiments, the memory interface component 112 includes at least the backend (444 in FIG. 4) referred to below. In some embodiments, the memory sub-system controller 115 includes at least a portion of the memory interface 112. For example, the memory sub-system controller 115 can include a processor 117 (processing device) configured to execute instructions stored in local memory 119 for performing the operations described herein. In embodiments, the processor 117 includes a plurality of cores 118 configured to implement the service applications and the FTL service framework disclosed herein. In some embodiments, the memory interface component 112 is part of the host system 110, an application, or an operating system.

In some embodiments, the memory sub-system controller 115 includes a service manager 113 that can also be combined, at least in part, with the memory interface component 112. The service manager 113 can include FTL logic that is considered common FTL (CFTL) and employed for executing service applications and the FTL service framework, which will be explained in more detail. In various embodiments, the memory sub-system controller 115 includes at least a portion of the service manager 113 and is configured to perform the functionality described herein, particularly in relation to facilitating inter-communication between service applications. In such embodiments, at least portions of the service manager 113 can be implemented using hardware or as firmware, stored on in the local memory 119 and/or in the memory device 130, and executed to perform the operations described herein. In some embodiments, one or more operations performed by the service manager 113 are performed by the local media controller 135 or other logic located on-board the memory device 130.

FIG. 1B illustrates the plurality of cores 118 of the memory sub-system controller 115 implementing a plurality of service applications and a flash translation layer (FTL) service framework 150 according to some embodiments. In various embodiments, the plurality of cores 118 includes a first core 118A, a second core 118B, up to an Nth core 118N. The plurality of cores 18 (and optionally also other FTL hardware) can be configured to execute a plurality of service applications that implement at least a portion of FTL logic to direct operations to be performed by the memory device 130 with reference to the data while tracking translations between a logical block address space to a physical address space. Further, the plurality of cores 118 can be configured to implement an FTL service framework 150 that includes a plurality of application programming interfaces or APIs 160 configured to standardize communication between the plurality of service applications across the plurality of cores during runtime operation of the plurality of cores. In embodiments, the FTL service framework 150 also includes or has access to a service directory 172 of the plurality of service applications. For example, the service directory 172 can be stored in the local memory 119 or one of the memory devices 130 and 140.

As illustrated, and only by way of a simplified example, the first core 118A includes a first service application A and a first instance of a second service application B, the second core 118B includes a third service application C and a second instance of the second service application B, and the Nth core 118N includes a fourth service application D and a third instance of the second service application B. One example of employing different instances of the second service application B is for different write services, e.g., one instance for a host data path (e.g., handling writes from the host system 120), another instance for a folding write data path (e.g., handling write requests for moving data from one block stripe to another to reclaim free space, which can be performed as part of garbage collection), and another for a flash data manager (FDM) data path (e.g., handling write messages coming from a write service manager or other FTL logic components).

In embodiments of the memory sub-system controller 115 disclosed herein, the APIs 160 facilitate FTL functionalities to allow multiple services to coordinate with each other to support the FTL main functionalities, such as address translation, folding, and the like. The FTL logic can translate logical addresses (of a logical address space) into physical addresses (of a physical address space) or vice versa to facilitate directing memory operations and the memory device 130. Since memory blocks (or such units) of the memory device 130 have to be erased before being rewritten, the APIs 160 provide a way for high-level software to initiate block erase operations. Some of the APIs 160 can also enable the FTL logic to trigger and control garbage collection processes at the memory device 130. In embodiments, the APIs can expose functions to monitor the wear level of the memory device 130 and the health of the memory sub-system 110, enabling software to take preventive measures to address health issues. Additionally, the APIs 160 can provide access to error detection and correction mechanisms with the FTL logic, enabling software to handle data integrity issues.

In various embodiments, the APIs 160 can further include different subsets of APIs that facilitate intercommunication and functionality between service applications, e.g., service and set registration APIs 164 and service request and status APIs 168, which will be discussed in more detail. In embodiments, various APIs can facilitate or perform registration of the plurality of service applications. For example, at least one of the APIs can register, with a unique identifier, each service application of the plurality of service applications to a particular core of the plurality of cores 118 and insert each service application into the service directory 172 that is capable of being queried. At least some of the plurality of APIs 160 can facilitate or perform request forwarding and status broadcasting, which further enables seamless communication between the plurality of service applications.

Whereas previously many interactions between service applications were statically performed, now the FTL service framework 150 can enable dynamic communication between the service applications at runtime. Thus, for example, the FTL service framework 150 can, at runtime, make determinations about service applications, such as, which service applications exist, how to contact such service applications, how to forward messages across the service applications, and the like. In this way, the FTL service framework 150 can manage functionality across the plurality of service applications at runtime.

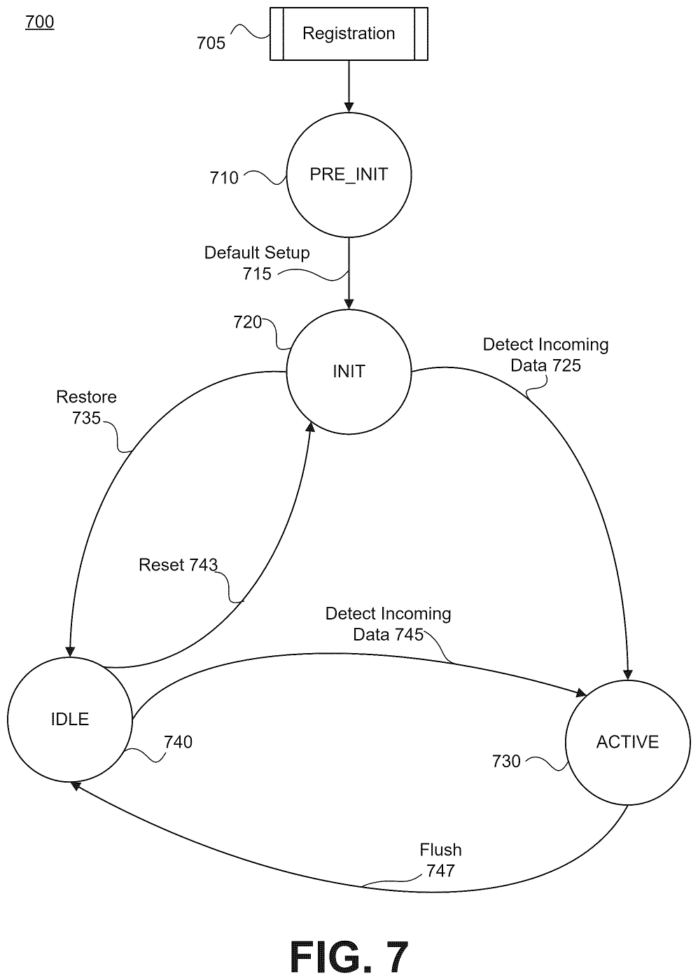

More specifically, in some embodiments, because the APIs 160 can be standardized across the FTL service framework 150, which can be implemented in a distributed way across the plurality of cores 118, the FTL service framework 150 enables each of the plurality of service applications to seamlessly communicate with each other, e.g., by passing messages that have a predetermined format. For example, service requests and statuses can be forwarded across the FTL service framework 150 to any of the services registered in the service directory 172. A service request can be a message that one service application can send to another service application for requesting a certain action. Actions can perform a particular service flow and can result in certain state changes (see FIG. 7). A service application can update its status to reflect the requested actions being completed and other status changes. Such statuses can be queried by other service applications, e.g., as performed through the FTL service framework 150. Table 1 is a summary of exemplary APIs 160, which can be respectively configured to reference the service directory 172 to be executed and that facilitate sending/receiving service requests and statuses associated with the plurality of service applications. Another API (not listed) can be a find a service that finds a service application using a service identifier, for example.

TABLE 1

| API | Function |
|---|---|
| FtlService_SendRequest | Send a service request to another service |
| | application to request a particular action |
| | be performed. Can be used for on-core and |
| | off-core requests. |
| FtlService_ClearRequest | Clear a service request after having |
| | performed the particular action. Used |
| | by a service application after serving |
| | a request. |
| FtlService_GetRequest | Retrieve a service request received from |
| | another service application. Used by a |
| | service application to retrieve a request. |
| FtlService_SetStatus | Set a status of an associated service |
| | application. Used by a service |
| | application to update its own status. |
| FtlService_GetStatus | Determine a status of the associated |
| | service application. Used by a service |
| | application to obtain its own status. |
| FtlService_QueryStatus | Query a status of another service |
| | application. Used by a service |
| | application to get a status of another |
| | service application. |
| FtlService_RegisterService | Register the associated service |
| | application locally on a particular core. |
| FtlService_RegisterProxy | Register a proxy service application |
| | to communicate with a related service |
| | application running on a different core. |

In some embodiments, at least a first API of the plurality of APIs 160 is configured to send a service request from a first service application to a second service application to request a particular action be performed by the second service application. In some embodiments, the FTL service framework 150 configures a list of common service requests that can be made from any service application to another service application while other service requests can be configured by particular service applications to be service-specific requests. Table 2 is a list of FTL-related service request types that include common service requests.

TABLE 2

| Service | |
|---|---|
| Request Type | Function |
| Request Work | A work request notifying the second service |
| | application of the particular action. |
| Request | A synchronization request prompting the second |
| Synchronization | service application to synchronize and flush data |
| | associated with the second service application. |
| Request Suspend | A suspension request prompting the second service |
| | application to suspend service. |
| Request Activate | An activate request prompting the second service |
| | application to activate service. |
| Request Reset | A reset request prompting the second service |
| | application to reset service. |
| Request Persist | A persist request prompting the second service |
| | application to store internal data to a particular |
| | memory location. |
| Request Restore | A restore request prompting the second service |
| | application to restore service. |
| Request Response | A response from a request prompting the second |
| | service application to transmit a response to a |
| | previously received service request. |

In some embodiments, the service-specific requests may include, for example, a write service request to eject a cursor (e.g., a location in the memory device 130 where data is next to be stored), a write service request queue to write to a target location at a particular block stripe, a write service request to notify of a state transition, a write service custom command response, a rewrite request to submit for a rewrite, or a write service update rate to update a write rate.

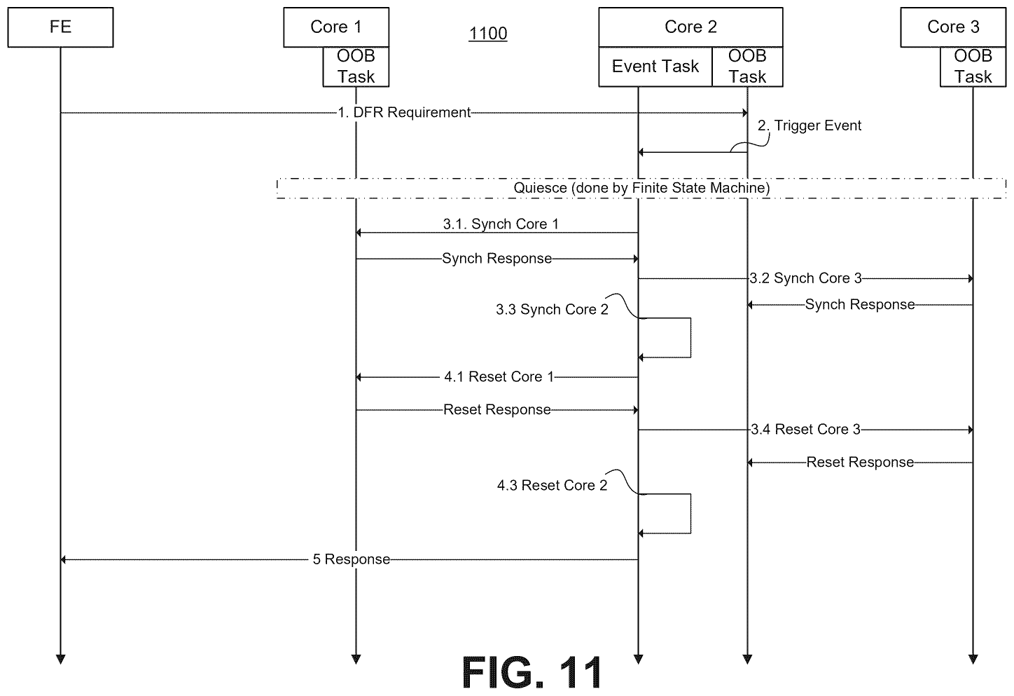

In certain embodiments, the controller 115 further includes an out-of-bounds (OOB) message handler 174 located at each of the plurality of cores 118 to handle OOB tasks related to auxiliary communication between the plurality of cores 118. In some embodiments, another OOB message handler 174 is included within the FTL service framework 150, or which may be shared each respective cores on behalf of the FTL service framework 150. In embodiments, the OOB message handler 174 facilitates OOB tasks such as lower-level communication between the plurality of cores such as a service request handler, a quiescence handler, and a vendor-specific handler. As just one example, the memory interface 112 (or frontend) may want to do a clean power down (CPD), for which the memory interface 112 goes through an OOB message queue. Going through the OOB message queue of the OOB message handler 174 can trigger a flag to indicate a CPD event, so an event-driven handler can get triggered while the OOB task is being performed separately. Additional description regarding the OOB message hander 174 can be found with reference to FIG. 11. In embodiments, vendor-specific commands are special commands sent from the host system 120 for vendor-specific testing or control purposes. For example, a vendor-specific command can be used to get the information of number of block stripes in the memory device 130, another can be used to check number of times a block stripe has been erased, etc.

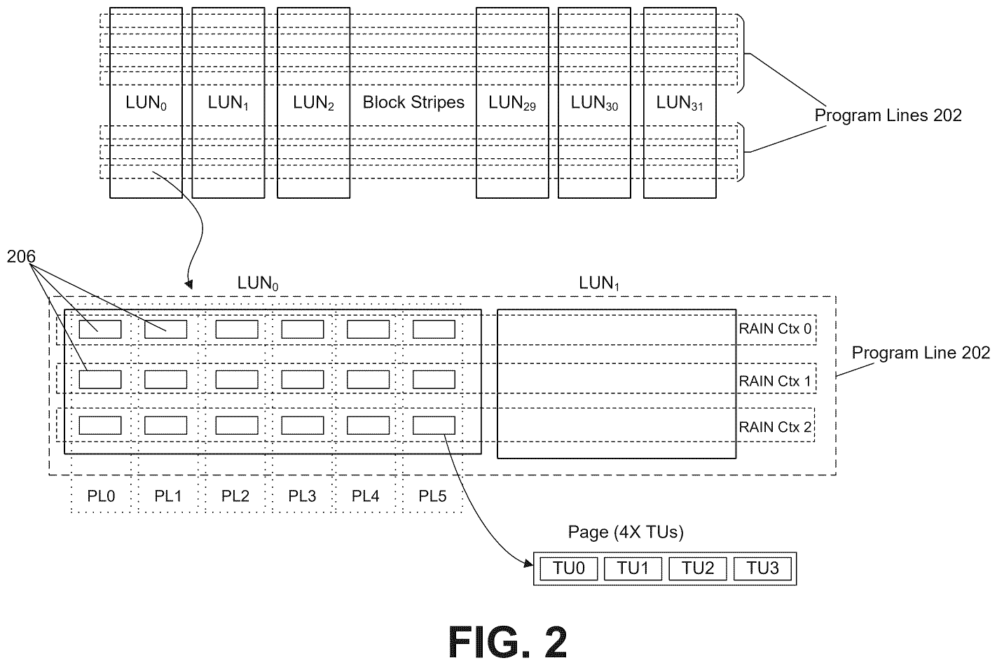

FIG. 2 is a block diagram depiction of a write sequencer arrangement of multiple dies and block stripes according to various embodiments. As illustrated, a number of program lines 202 can be arranged corresponding to block stripes, which is a method of organizing and accessing data across multiple blocks (e.g., super blocks) across multiple dies (e.g., LUN₀ to LUN₃₁) to improve performance and reliability. This type of organization is similar to the striping technique used in Redundant Array of Independent NAND (RAIN) systems, where data is distributed across multiple disks to achieve parallelism and redundancy. Both block striping and RAIN-based striping are envisioned and will be referred to herein.

In an embodiment, the bottom, inset portion of the block diagram is a zoomed-in view of two adjacent dies (e.g., LUN₀ and LUN₁) of a single program line 202 that is intersected by multiple planes (e.g., PL0 through PL5). At the intersection of RAIN context lines of the program line 202 and the multiple planes are multiple pages 206. As an example, each page of the multiple pages 206 includes space for data of four translation units (TUs). A TU can be understood as a group of blocks that the FTL logic manages as a single entity for the purposes of logical-to-physical (L2P) address translation and other operations. The FTL can, for example, manage the mapping of TUs, ensuring that each TU from the host corresponds to the correct physical units in the memory device. The FTL can also make sure the placement of TUs on the NAND following a write, and to enhance performance, maintains wear leveling and efficient garbage collection. The FTL can also maintain the integrity of the TUs during read, write, and erase operations, ensuring that data remains consistent and accurate.

In some embodiments, only by way of example, each program line 202 across a die (or LUN) can be 72 times 4,000 bytes of data (e.g., 288 KB), which would go into a single backend command. The write sequences would need to sequence the data with a smallest footprint as fast as possible, which motivates the solutions of the present disclosure because backend commands are getting larger. Also, each program line 202 may have different numbers of pages at different planes depending on the memory type. For example, memory configured as single-level cell (SLC) memory would have one page while memory configured as multi-level cell (MLC) memory would have multiple pages. The MLC memory could be bi-level cell, triple-level cell (TLC), or quad-level (QLC), or higher-level cell memory. Thus, for MLC type memory, the physical-to-logical address translation can include multiple pages across planes of several dies. Cursor logic would need to know when to close out one write command (e.g., backend write command) and start aggregation of write messages for the next write command, which depends on memory type.

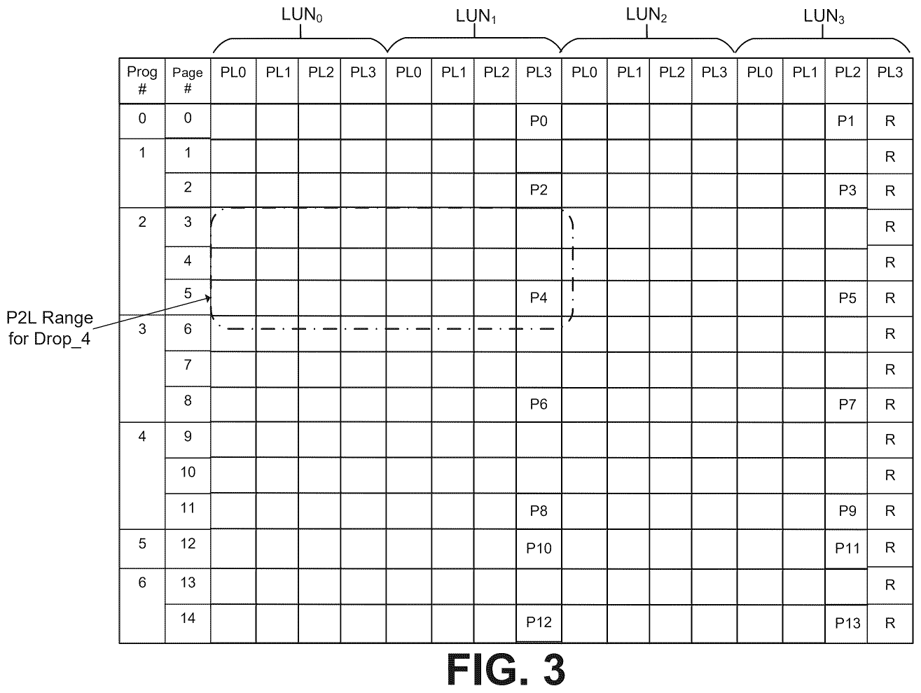

FIG. 3 is a graph depiction of a write sequencer arrangement of multiple dies and an example logical-to-physical (P2L) address range across planes of the multiple dies that might make up different write commands according to various embodiments. Only by way of example, the top of the graph indicates that four dies (LUN₀ through LUN₃) are each organized into four planes. The left-most column organizes program lines and the next column from there indicates page number. Only by way of example, logical-to-logic (P2L) address range for Drop 4 is illustrated spanning across pages 3, 4, and 5, and the planes of LUN₀ and LUN₁. The term “Drop” here connotes that a particular write command needs to be generated, e.g., as a backend command, due to a TU buffer being full. When this TU buffer is full, then the write data is “dropped” from the TU buffer, e.g., written, to the memory device at the specified location of the P2L address range specified in the criteria set received from the cursor logic.

In some embodiments, the page/plane intersections (e.g., blocks) with P numbers (e.g., P0, P1, P2, P3, and so forth) are reserved for P2L drop metadata (e.g., metadata describing the aggregated TUs stored in the rest of the Drop area). For example, the TUs written to the area described by Drop 4 in FIG. 3 can include other useful information such as for performing FTL data management, e.g., as garbage collection and wear leveling. In some embodiments, the P2L drop metadata facilitates reverse lookup to find where the data maps to in NAND, e.g., TUA1000 maps to which NAND address. In embodiments, the FTL logic may need to perform a reverse address lookup before folding data into a new block stripe.

With additional specificity, TU addresses (TUAs) are logical address used by the host system 120 to specify TU data. When the host system 120 wants to write TU data, the host system 120 commands the FTL logic what TUA the TU should be associated with, and the FTL logic can write this data to the memory device 130 at a specific NAND location, e.g., a physical address. At this time, a section of metadata is added to the TU data as part of a NAND write command, which can begin as a backend command. When writing to the location is completed, the mapping from TUA to the physical NAND address can be written to a L2P table or other data structure. When the host system 120 attempts to read the TU data, in some embodiments, the host system 120 sends the TUA as part of a read command, performs an FTL logic query of the L2P table to determine the NAND physical address, and sends a backend read command to read the actual TU data out of the location of the memory device 130. In embodiments, the TUA is stored as part of metadata (as part of NAND write earlier), which can be read out to check if the TU read actual matches TUA asked by the host system 120, e.g., by way of a read error check.

In some embodiments, the last column of the four dies is plane three (PL3), which is also the last block of a corresponding program line and page number. The “R” in each of these last page/plane intersections (e.g., blocks) is for writing the RAIN parity data useable to restore lost data in the event of data corruption.

FIG. 4 is an example sub-system controller 415 that includes a write service manager 413 and other supporting components for backend command generation and related P2L/L2P tracking according to some embodiments. In some embodiments, at least a portion of the FTL components of the write service manager 413 (whether or not illustrated) are considered a write service application having CFTL components that are modularized for deployment in different FTL design architectures. In such embodiments, the controller 415 is the memory sub-system controller 115 of FIG. 1A. The controller 415 can include a page map 402, a frontend 404, a write service manager 413, an LBA translator 442, an L2P service manager 440, a backend 444, a backend response queue 448, and a response router 450. In at least some embodiments, the write server manager 413 includes different FTL components, including at least a write sequencer 410, cursor logic 414, a RAIN bin manager 418, a block stripe scoreboard 420, a P2L writer 424, streamer logic 430, a write message queue 434, a backend command (BCmd) reuse queue 438, and a response handler 460.

In some embodiments, the page map 402 is stored in the local memory 119 and includes information about the NAND page layout of a block, for example, by specifying how many pages exists in a NAND block, what pages should be grouped together as a programming line, and at what order the pages should be programmed. For this reason, the information in the page map 402 is NAND-type specific in nature. The write sequencer 410 can employ the page map 402 to build the page/plane mapping depiction of FIG. 3, enabling tracking of groupings of write locations in the memory device 130 according to page number, program line, planes, and dies. In embodiments, the cursor logic 414 can access the write sequencer 410, as well as the RAIN bin manager 418, the block stripe scoreboard 420, and P2L writer 424 in order to perform various functionalities that will be described. In embodiments, the cursor logic 414 determines when the end of a program line is reached (see FIG. 2) and a new program line is to be started. The cursor logic 414 can also determine whether there are certain planes that need to be skipped due to bad planes.

The stripping techniques of RAIN and block stripes was previously introduced and are known techniques to achieve parallelism and redundancy, which enhance programming efficiency. In embodiments, the RAIN bin manager 418 stores and tracks RAIN context information used to maintain integrity, redundancy, and efficient operation of the memory sub-system 110, including performance optimizations. This RAIN context information (e.g., “contexts”) can include metadata such as block/page statuses, redundancy information such as parity data and RAIN level configuration. In embodiments, the block stripe scoreboard 420 tracks the progress of writes on the block stripe to which is being programmed.

In at least some embodiments, the cursor logic 414 generates a criteria set 425 (e.g., a type of write command recipe) associated with generating a backend command 445 (or BCmd), by the streamer logic 430, to be sent to the memory device 130. For example, the backend command 445 can be a write command that directs the memory device 130 in writing TU data, associated with the plurality of TUs, to a memory array of the memory device 130. In different embodiments, the cursor logic 414 is either dedicated hardware or a processing core. In some embodiments, the cursor logic 414 stores the criteria set 425 in a memory such as the local memory 119 and/or the memory device 140. The cursor logic 414 can then provide, to the streamer logic 430, a pointer to the memory where the criteria set 425 is stored, e.g., so that the streamer logic 430 can access the criteria set in the memory.

In some embodiments, the criteria set 425 includes a location in the memory array where a write command should be performed in response to the backend command 445 and how the TU data is to be organized for being written to the location in the memory device 140. In embodiments, the criteria set 425 further includes at least two of the following: a size of a page group including an aggregated plurality of TUs, a number of valid buffers for the page group, P2L translation-specific information, a first bitmask for bad planes of the memory device 140, a second bitmask for parity planes of the memory device, RAIN-related information, and a flash logical address of the backend command 445. This type of information enables the streamer logic 430 to understand how many aggregated TUs are expected for each backend command 445 and how to formulate the LBA range to be programmed based on a present cursor state and available locations in the memory array, e.g., as illustrate in FIG. 3.

In some embodiments, the cursor logic 414 further opens and closes a block stripe across a plurality of planes of the memory device 140, allocates and track RAIN contexts of the memory device 140, interacts with the write sequencer 410 to layout how write operations are to be ordered, interacts with a physical-to-logical (P2L) write unit (e.g., the P2L writer 424) to open and close P2L buffers, and handles RAIN parity writes. The cursor write logic 414 can further direct the streamer logic 430, e.g., via the criteria set 425, save and restore cursor states for power cycles (which will be discussed in more detail), and can direct moving data from one location to another with the memory device 130 or 140.

In embodiments, the streamer logic 430 is coupled between the cursor logic 414 and the backend 444 that interfaces with the memory devices 130 and 140. In different embodiments, the streamer logic 430 is hardware, a special pattern of data to be processed, software, firmware, or a combination thereof. The streamer logic 430 can thus access and employ the criteria set 425 (e.g., write command recipe) to perform various FTL operations. For example, if the criteria set 425 was stored in the memory (such as the local memory 119 or the memory device 140), the streamer logic 430 can access the location in memory associated with the pointer received from the cursor logic 414 to access and use the criteria set 425. In embodiments, the streamer logic 430 aggregates, according to the criteria set, a plurality of TUs received in one or more write messages 435, e.g., from the write message queue 434. The write message queue 434 can buffer write messages 435 received from different components of the frontend 404 as well as from FTL components of write service manager 413. In embodiments, the criteria set 425 enables accessing the plurality of TUs within a first format, of the one or more write messages 435, that depends on a data path associated with the one or more write messages 435. In some embodiments, the streamer logic formats the aggregated plurality of TUs into the backend command 445 (BCmd) having a second format for transmittal to the memory device 140 via the backend 444.

In some embodiments, the data path varies and thus, multiple write service managers 413 can exist to include multiple streamer logic components, each configured for or adapted to a different data path. As such, the streamer logic 430, as illustrated, is an exemplary streamer logic component of many possible streamer logic components. In such embodiments, the data path is one of a host data path (e.g., handling writes from the host system 120), a folding write data path (e.g., handling write requests for moving data from one block stripe to another to reclaim free space, which can be performed as part of garbage collection), a flash data manager (FDM) data path (e.g., handling write messages coming from the write service manager 413 or other FTL components), a post-persist physical-to-logical drop recovery data path (e.g., handling flushing and recovery of in-flight data at APL/CPD), or a unit test write data path (e.g., handling write messages associated with test write commands).

In embodiments, the streamer logic 430 interacts with the write message queue 434 to retrieve TU data buffer addresses and TU address information in order to aggregate the plurality of TUs. The streamer logic 430 can also update entries in a physical-to-logical (P2L) buffer associated with the TU address (or TUA) information. When the P2L mapping is reversed, the streamer logic 430 can determine a TUA for data at a specific location in the memory device 130 or 140. The streamer logic 430 can also transmit the backend command 445 to the memory device 130 or 140.

In embodiments, the streamer logic 430 enables reuse of entries within a backend command buffer (not illustrated) for subsequent write commands. For example, the backend command buffer can be reserved in the local memory 119 or the memory device 140 and can be limited to a certain number of backend command entries. By reusing the backend command entry that is already buffered for the next backend command 445, the streamer logic 430 can avoid releasing the backend command entry and reallocating the buffer entry all over again for the new backend command. The streamer logic 430 can further enable reuse of a pool of pre-allocated backend commands in generating the backend command 445. In some embodiments, the BCmd reuse queue 438 is located in the local memory 119 or the memory device 140 to include the backend command buffer, which is available to the streamer logic 430.

In various embodiments, responses from the memory device 130 (which can include statuses of progress of completing a write operation corresponding to a backend command) can be received at the backend response queue 448. In such embodiments, the response router 450 can process responses from the memory device 130 and decide whether to forward the responses to an error handling service (not illustrated) or the response handler 460 if not related to error messages. The response handler 460 can then perform updates, depending on the type of information in the response, to one or more of the RAIN bin manager 418, the block stripe scoreboard 420, the P2L writer 424, or the BCmd ruse queue 438. As just one example, the criteria set 425 stored by the cursor logic 414 for a particular backend command 445 can include a field used to track the last aggregation location targeted by the streamer logic 430 and another field used to track the remaining space for writing, e.g., slots pending to be aggregated with user TUs. Feedback in responses from the memory device 140 can include such information, e.g., the last aggregation location and available slots for further TU aggregation, which the cursor logic 414 can update in either or both of the RAIN bin manager 418 and block stripe scoreboard 420.

In some embodiments, the FTL components for the memory sub-system controller 415 are stable and intended for reuse as much as possible across different FTL design architectures and/or platforms, e.g., and thus considered to be CFTL code and/or logic. For example, the write service manager 413 can include at least a portion considered to be a write service application of the plurality of service applications (see FIG. 1B). In embodiments, the LBA translator 442 and the L2P service manager 440 (along with an L2P scoreboard and an L2P miss list, which are not illustrated) are together considered to be an L2P service application deployed to assist other service applications in performing L2P translations. In some embodiments, such an L2P service application is also an CFTL-based service application. In varying embodiments, other CFTL-based service applications include a block stripe service manager or BSM service application and an error handle service application (not illustrated), but should be understood as other examples of the plurality of service applications referred to in FIG. 1B.

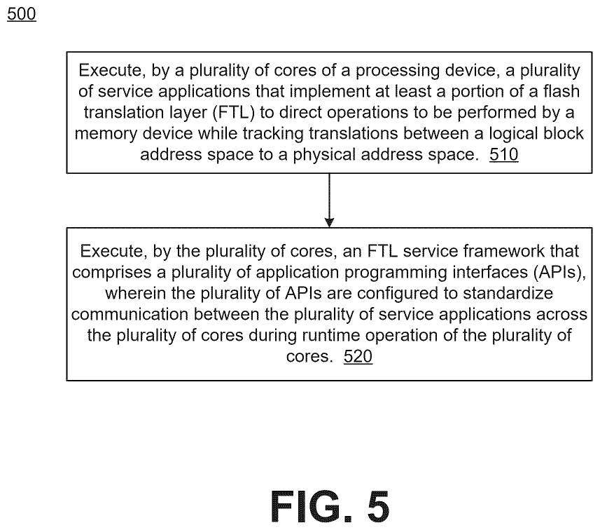

FIG. 5 is a flow diagram of an example method 500 of employing an FTL service framework that standardizes communication between a plurality of service application according to some embodiments. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the service manager 113 of FIG. 1A. In some embodiments, the method 500 is performed by the plurality of cores 118 of FIGS. 1A-1B. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 510, the processing logic executes a plurality of service applications that implement at least a portion of a flash translation layer (FTL) to direct operations to be performed by the memory device 130 with reference to the data while tracking translations between a logical block address space to a physical address space and/or between the physical address space and the logical address space.

At operation 520, the processing logic executes the FTL service framework 150 that includes a plurality of APIs 160. In embodiments, the plurality of APIs 160 are configured to standardize communication between the plurality of service applications across the plurality of cores 118 during runtime operation of the plurality of cores 118, e.g., of the memory sub-system controller 115.

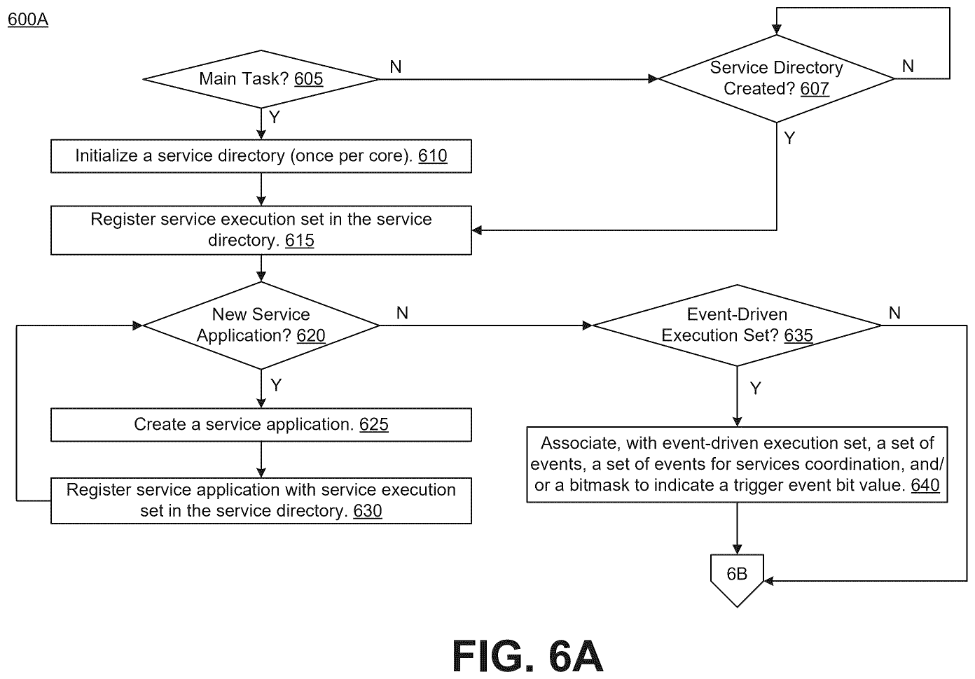

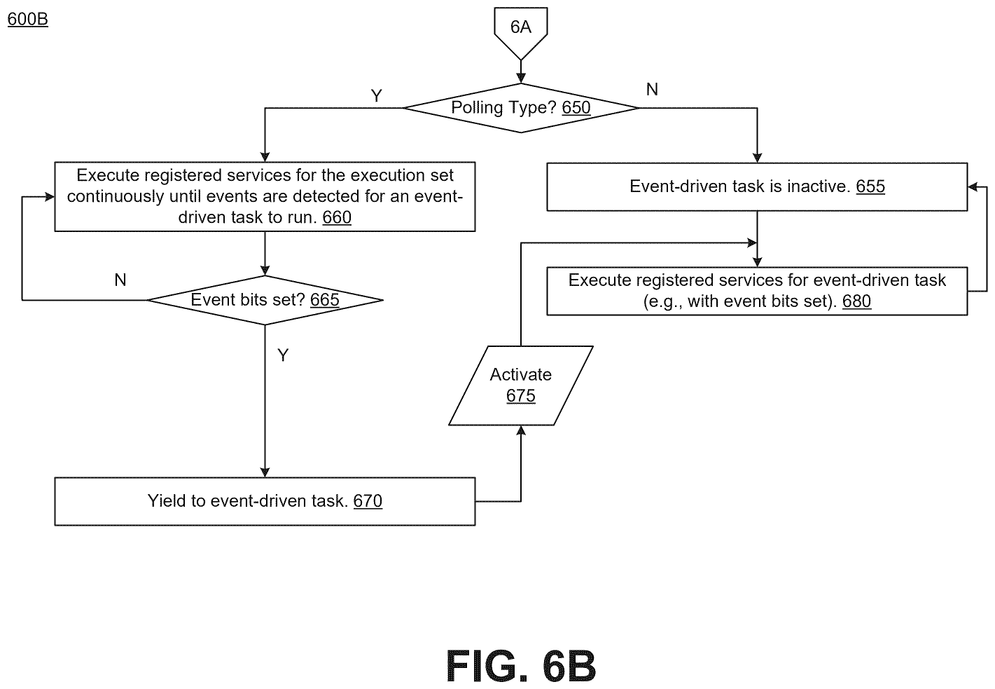

FIG. 6A is a flow diagram of an example method 600A of creating and registering service applications according to various embodiments. The method 600A can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600A is performed by the service manager 113 of FIG. 1A. In some embodiments, the method 600A is performed by the plurality of cores 118 of FIGS. 1A-1B, to include operation of the FTL service framework 150. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 605, the processing logic determines whether a main task is being executed. The main task can be understood as the main processing thread or code being executed on a processor core. If, at operation 605, the main task is detected being processed, then, at operation 610, the processing logic initializes the service directory 172, which can be performed once per core for the plurality of cores 118.

At operation 615, the processing logic registers a service execution set in the service directory 172. In embodiments, a service execution set is a set of service applications grouped together, or classified, by service type. In some embodiments, for example, the processing logic runs the service applications as a group that comprises the service execution set, e.g., on a particular task or processing thread.

In some embodiments, the service execution set includes a plurality of service applications of a polling type that are configured to execute continuously to completion except in response to event-based interruptions from event-driven service applications. As such, service applications of a polling type receives the highest priority service so as to be completed as soon as possible. In embodiments, these polling types of service applications include a write service application, response routing application, and response handling application. In embodiments, these polling type of service applications further include a BSM service application, a data path service application, such as a write, read, or erase service application.

In some embodiments, the service execution set includes a plurality of applications of an event-driven type that are configured to execute in response to detecting an FTL-related event, e.g., which may be triggered by receipt of (or detecting) a message or event at the frontend 404. Some examples of event-driven service applications include an FTL data flush to store data to the memory device 130, e.g., before a power down, and an FTL region load, which loads a map of data for a particular region, including an L2P mapping, after power up. As for the latter, after power up, the L2P table is repopulated with a region mapping of user data, e.g., so that the L2P service manager 440 and LBA translator 442 (and other such FTL components) can resume operation.

If, at operation 605, the main task is not detected as being executed, then, at operation 607, the processing logic determines whether the service directory 172 has been created or initiated. Once the service directory 172 has been created (e.g., initiated), then the method 600A can flow to operation 615, which was just discussed.

At operation 620, the processing logic determines whether a new service application is to be created. For example, the processing logic (which can be firmware) can know what service applications to activate for a product, depending on product configuration or just by design, which can be a part of core initialization with the memory sub-system controller 115.

If yes, at operation 625, the processing logic creates the new service application, e.g., according to runtime configurations which can include allocating memory and code required to execute the new service application.

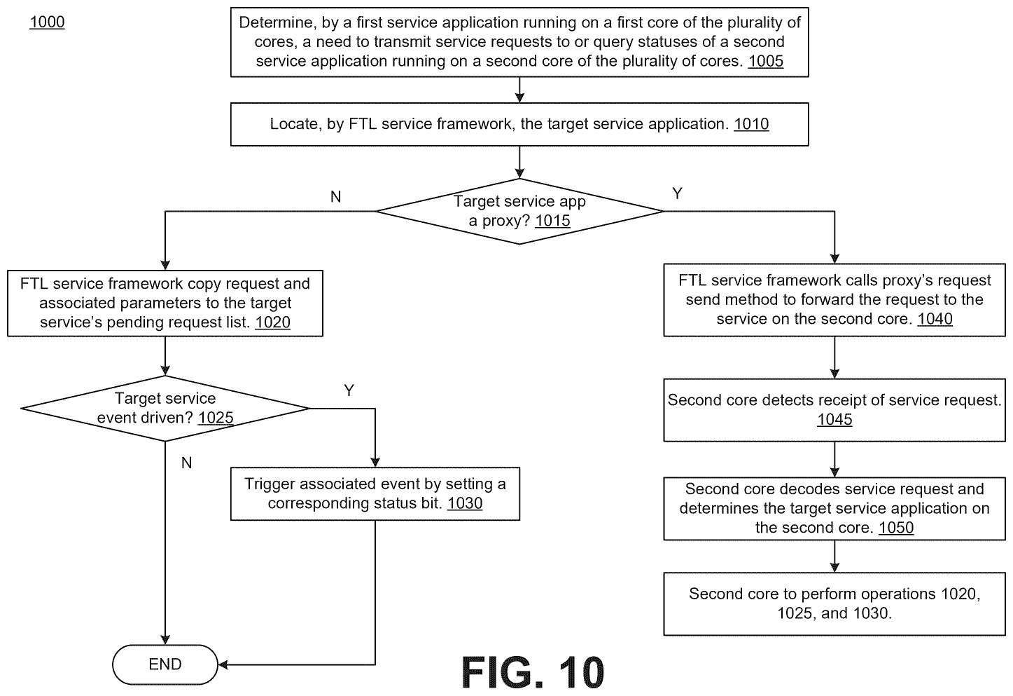

At operation 630, the processing logic registers the new service application with the service execution set that was already registered in the service directory at operation 615. In some embodiments, the new service application is a proxy service application that is to run on a first core to provide transparent communication with the actual service application running on a second core. Proxy service application will be discussed in more detail with reference to FIG. 10.

If, at operation 620, there are no further new service applications to be registered with a particular service execution set, the processing logic, at operation 635, determines whether the registered service execution set is an event-driven execution set. If it is not, the method 600A can flow to FIG. 6B. If yes, then at operation 640, the processing logic associates, with the service execution set, at least one of: a set of events, each of which is associated with a service registered with the service execution set, a set of events for services coordination, or a bitmask to indicate a trigger event bit value associated with each respective service application of the service execution set.

FIG. 6B is a flow diagram of an example method 600B of managing execution of service applications according to various embodiments. The method 600B can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600A is performed by the service manager 113 of FIG. 1A. In some embodiments, the method 600A is performed by the plurality of cores 118 of FIGS. 1A-1B, to include operation of the FTL service framework 150. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 650, the processing logic determines whether a polling type service execution set is being executed, e.g., on the main task. In some embodiments, first bits can be stored in a memory location (e.g., in a register, the local memory 119, or in the memory device 130 or 140) that indicate whether a core is executing an application service of a polling type. In contrast, second bits can be stored in the memory location in response to detecting a event that triggers execution of a service execution set of an event type. In this way, the processing logic can detect what kind of process/task to execute based on distinguishing the first bits (or polling type bits) from the second bits (or event-driven type bits). Thus, when an event is detected (such as a power up or a power down event), at least some core logic can assert or store the second bits in the memory location.

If at operation 650, the answer is no, then at operation 655, any event-driven task is inactive that has not yet been triggered. An event-driven task can be understood to be a processing thread or code portion to be executed only if a particular event is triggered.

If, at operation 650, a service execution set of a polling type is being executed, then, at operation 660, the processing logic executes registered services for the execution set continuously until FTL-related events are detected for an event-driven task to run.

At operation 665, the processing logic determines whether the second bits (or event bits) are set at the memory location. If not, the processing logic continues executing the registered services for the execution set at operation 660.

If, at operation 665, the event bits are detected as being set, then at operation 670, the processing logic yields to an event-driven task for which the event bits were detected. In some embodiments, at operation 675, the processing logic triggers activation of a particular event-driven task in response to the polling type execution set yielding to the event-driven task.

At operation 680, the processing logic executes registered services for the event-driven task (e.g., associated with the event bits being set) and loops back to an inactive state at operation 655. Upon entering such an inactive state, the polling type service application set of service applications can resume execution on the main task.

In some embodiments, one of the service applications can include a dummy or test service application (“testing agent”) to test the ability of other service applications to interact successfully with this testing agent. The testing agent can just receive and respond to a request without doing anything. This alone can validate the ability of a service application to send requests and receive responses and do other actions related to such communication. For example, the testing agent could test the ability of the write service application to conduct error handling when the write service application tries to open a new block stripe via sending a request to the BSM service application, and a dummy BSM service can fake either a success or a failure to test whether the write service can properly react to the response.

FIG. 7 is a flow diagram of an example method 700 representing common state logic for each FTL service application according to some embodiments. In some embodiments, the common state logic is executed as a state machine for tracking FTL activity associated with one or more service applications. The method 700 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 700 is performed by the service manager 113 of FIG. 1A. In some embodiments, the method 700 is performed by the plurality of cores 118 of FIGS. 1A-1B, to include operation of the FTL service framework 150. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 705, the processing logic registers, with a unique identifier, each service application of the plurality of service applications to a particular core of the plurality of cores. At operation 710, the processing logic causes the state logic to enter a pre-initialization state for each registered service application.

At operation 715, the processing logic performs a default setup for each service application. Specifically, each service application can perform any extra setup operation that can only be done when all the service applications are registered. For example, the processing logic can initialize one or more doublewords (DWs) in shared memory (e.g., the local memory 119 and/or the memory device 130 or 140) to provide status bits for tracking states and state transitions of the state logic for the plurality of service applications.

TABLE 3

| | | Size | | |
|---|---|---|---|---|
| DW | Offset | (bits) | Name | Description |
| 0 | 0 | 4 | state | Service current state |
| | 4 | 1 | requestPending | Service has pending |
| | | | | requests to process |
| | 5 | 1 | clean | 1 if the service's all |
| | | | | persist-able data has been |
| | | | | saved |
| | 6 | 4 | synced | Service is synced to the |
| | | | | boundary specified by |
| | | | | this field |
| | 10 | 14 | reserved | Unused |
| | 24 | 8 | error | Error reported by the |
| | | | | service |
| 1 | 0 | 32 | Suspend Status | Service current Suspend |
| | | | | Status |

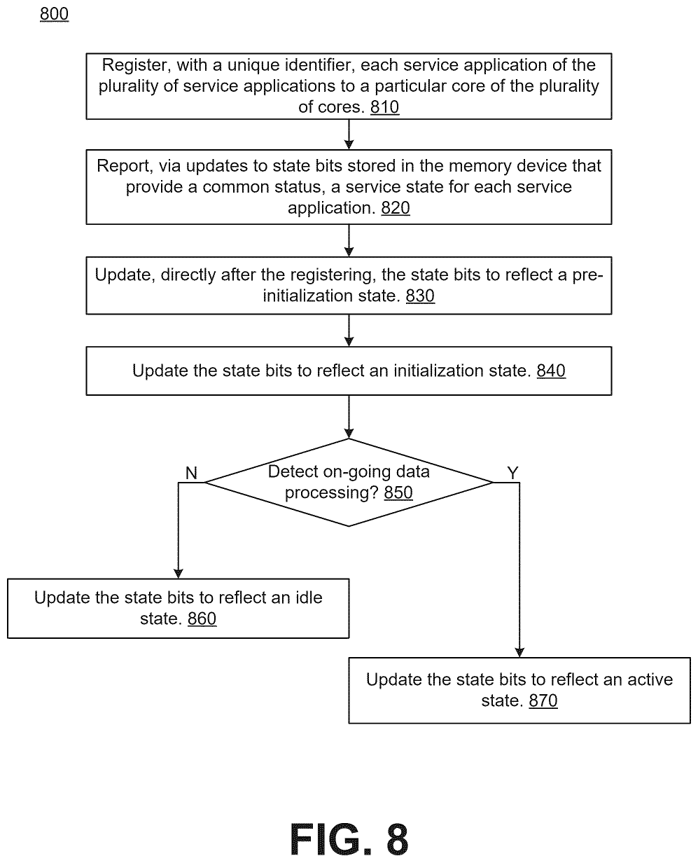

In embodiments, the processing logic maintains, in the memory device 130, one or more doublewords of bits indicating one or more statuses associated with each service application of the plurality of service applications. In embodiments, a first subset of the one or more doublewords are predefined and a second subset of the one or more doublewords are service-specific statuses. These status bits will also be referred to in more detail with reference to FIG. 8. Table 3 is just one example of bits across the one or more doublewords that can be set to track statuses, which may involve these states.

At operation 720, the processing logic causes the logic to enter an initialization state for each service application. From the initialization state, the processing logic can restore the service application to a previously persisted state. The initialization state may also be entered after a power up or after a reset. If a service application does not support persist/restore, the service application can enter the idle state directly. Note that not all service applications will then pass through the remainder of the FSM logic states described below, but these states and transitions are described for an understanding of possible states and possible flows through these states.

At operation 725, the processing logic detects incoming data, e.g., received by a particular service application.

At operation 730, the processing logic causes the state logic to enter an active state in which the particular service application processes data based on its configuration.

At operation 735, the processing logic causes the state logic receives a service restore request, e.g., in order to restore the service application to idle state after power up.

At operation 740, the processing logic causes the state logic to enter an idle state, e.g., in response to receipt of the service restore request at operation 735.

At operation 743, the processing logic detects a service reset request, e.g., requesting to reset the state bits in the doubleword for the particular service application.

At operation 720, the processing logic causes the state logic to return to the initialization state.

At operation 745, the processing logic causes the state logic to again detect incoming data, e.g., while in the idle state entered at operation 740.

At operation 730, the processing logic causes the state logic to again enter the active state in order to handle and process that data, as configured to do.

At operation 747, the processing logic detects a flush of data from the particular service application, which could indicate that data handling has ceased or that a power down operation is occurring and any in-flight data needs to be stored back to the memory device 130.

At operation 740, the processing logic causes the state logic to again enter into the idle state due to having flushed data from the particular service application.

In some embodiments associated with the method 700, each service application is expected to update a status within the one or more doublewords in a timely fashion. For example, for block stripe retirement service application, the service application may need to update a customized service bit to indicate if there is a pending block to be retired. For a folding service application, the service application can report a current folding victim block (e.g., from where data is being retrieved to be written elsewhere). For a write service application, the service application can use particular bits to report its remaining free space of cursor locations for physical location tracking. In some embodiments, a service status is not a replacement for other more complicated data access. For example, if possible, a basic inter-service application can be utilized to reduce APIs coupled between service applications, where possible.

FIG. 8 is a flow diagram of an example method 800 of registering and initializing the service states according to some embodiments. The method 800 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 800 is performed by the service manager 113 of FIG. 1A. In some embodiments, the method 800 is performed by the plurality of cores 118 of FIGS. 1A-1B, to include operation of the FTL service framework 150. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 810, the processing logic registers, with a unique identifier, each service application of the plurality of service applications to a particular core of the plurality of cores 118.

At operation 820, the processing logic reports, via updates to state bits stored in the memory device that provide a common status, a service state for each service application. The doubleword of memory for retaining state bits and various state transitions that can be performed with these bits was discussed with reference to FIG. 7.

At operation 830, the processing logic updates, directly after the registering, the state bits to reflect a pre-initialization state for each service application.

At operation 840, the processing logic updates the state bits to reflect an initialization state, e.g., for each service application after perform the default setup at operation 715.

At operation 850, the processing logic, determines whether on-going data processing is occurring at the particular service application.

At operation 860, the processing logic, in response to the service application having no on-going data processing, updates the state bits to reflect an idle state.

At operation 870, the processing logic, in response to the service application undergoing data processing, updates the state bits to reflect an active state.

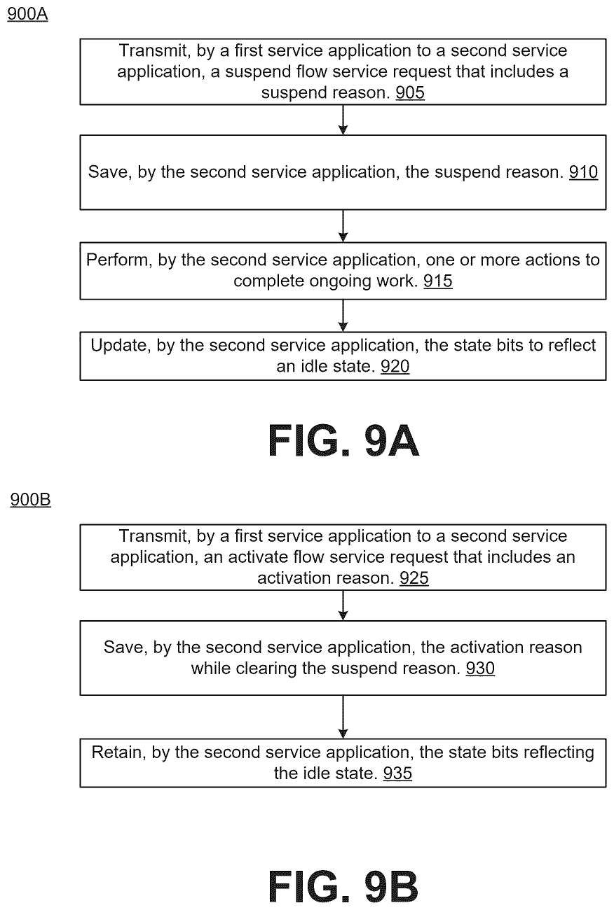

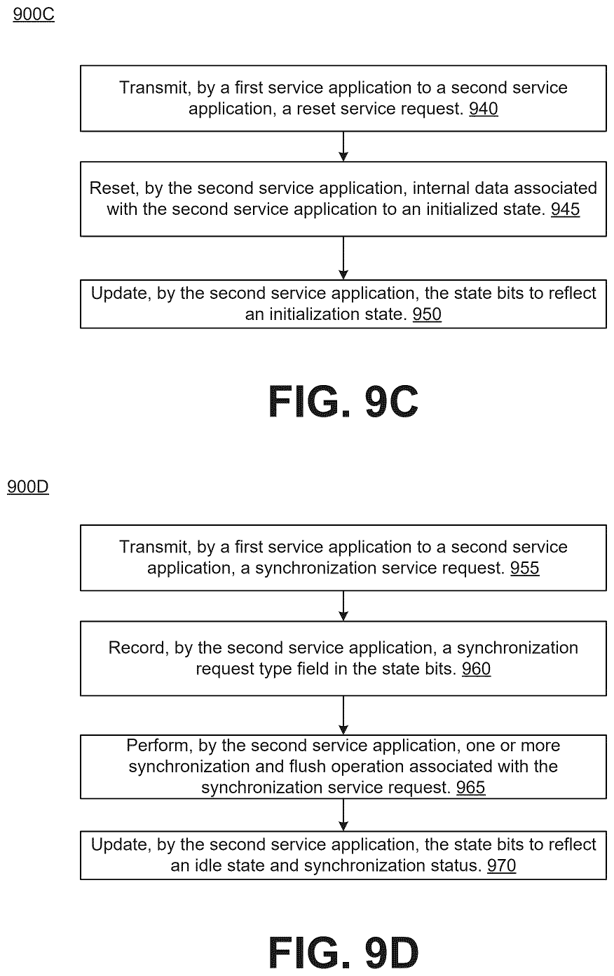

FIG. 9A is a flow diagram of an example method 900A for a service suspend flow according to some embodiments. The method 900A can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 900A is performed by the service manager 113 of FIG. 1A. In some embodiments, the method 900A is performed by the plurality of cores 118 of FIGS. 1A-1B, to include operation of the FTL service framework 150. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 905, the processing logic transmits, by a first service application to a second service application, a suspend flow service request that includes a suspend reason. In embodiments, the second service application is a targeted service application that could be on any of the plurality of cores 118. After the request is sent, a suspend initiator of the first service application can poll the targeted service application suspend status value to see if the targeted service application has acknowledged the suspend request.

At operation 910, the processing logic saves, by the second service application, the suspend reason.

At operation 915, the processing logic performs, by the second service application, one or more actions to complete ongoing work.

At operation 920, the processing logic updates, by the second service application, the state bits to reflect an idle state. The processing logic an also update the suspend status with the suspend reason saved earlier.

FIG. 9B is a flow diagram of an example method 900B for a service activate flow according to some embodiments. The method 900B can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 900B is performed by the service manager 113 of FIG. 1A. In some embodiments, the method 900B is performed by the plurality of cores 118 of FIGS. 1A-1B, to include operation of the FTL service framework 150. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 925, the processing logic transmits, by a first service application to a second service application, an activate service request that includes an activation reason. In embodiments, the second service application is a targeted service application that could be on any of the plurality of cores 118. After the request is sent, a activation initiator of the first service application can poll the targeted service application suspend status value to see if the targeted service application has acknowledged the activation request.

At operation 930, the processing logic saves, by the second service application, the activation reason while clearing the suspend reason.

At operation 935, the processing logic retains, by the second service application, the state bits reflecting the idle state. In embodiment, the processing logic also updates the suspend status with clearing the corresponding suspend reason from the activation reason bits.

FIG. 9C is a flow diagram of an example method 900C for a service reset flow according to some embodiments. The method 900C can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 900C is performed by the service manager 113 of FIG. 1A. In some embodiments, the method 900C is performed by the plurality of cores 118 of FIGS. 1A-1B, to include operation of the FTL service framework 150. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 940, the processing logic transmits, by a first service application to a second service application, a reset service request. In embodiments, the second service application is a targeted service application that could be on any of the plurality of cores 118. After the request is sent, a reset initiator of the first service application can poll the targeted service application common status value to see if the targeted service application has transitioned to the initialization state.

At operation 945, the processing logic resets, by the second service application, internal data associated with the second service application to an initialized state.

At operation 950, the processing logic updates, by the second service application, the state bits to reflect an initialization state.

FIG. 9D is a flow diagram of an example method 900D for a service synchronization flow according to some embodiments. The method 900D can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 900D is performed by the service manager 113 of FIG. 1A. In some embodiments, the method 900D is performed by the plurality of cores 118 of FIGS. 1A-1B, to include operation of the FTL service framework 150. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 955, the processing logic transmits, by a first service application to a second service application, a synchronization service request. The payload can be used to specify the synchronization request type. In embodiments, the second service application is a targeted service application that could be on any of the plurality of cores 118. After the request is sent, a synchronization initiator of the first service application can poll the targeted service application common status value to see if: 1) the state of the target service application has transitioned to an idle state; and 2) the synchronized field of the common status has been set to match the synchronization request type set by the first service application.

At operation 960, the processing logic records, by the second service application, a synchronization request type field in the state bits.

At operation 965, the processing logic performs, by the second service application, one or more synchronization and flush operation associated with the synchronization service request.

At operation 970, the processing logic updates, by the second service application, the state bits to reflect an idle state and a synchronization status. In some embodiments, the processing logic can further update the synchronized field of the common status with the recorded synchronization request type.

FIG. 10 is a flow diagram of an example method 1000 of service proxy registration and a service request transmission flow according to some embodiments. The method 1000 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 1000 is performed by the service manager 113 of FIG. 1A. In some embodiments, the method 1000 is performed by the plurality of cores 118 of FIGS. 1A-1B, to include operation of the FTL service framework 150. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 1005, the processing logic determines, by a first service application running on a first core of the plurality of cores, a need to transmit service requests to or query statuses of a second service application running on a second core of the plurality of cores.

At operation 1010, the processing logic locates a target service application, which could be executing on the first core or on the second core, where the latter could be associated with (or be identified as) the second service application.

At operation 1015, the processing logic determines whether the target service application is a proxy service application, e.g., through which connection to second service application is intended. For example, a proxy service application can run on the first core to provide transparent communication with the second or target service application running on the second core.

In response to, at operation 1015, the target service application not being a proxy service application, the processing logic, at operation 1020, copies the service request and associated parameters to a request list of the target service application.

At operation 1025, the processing logic determines whether the target service application is event driven. If not, the method 1000 can end. If yes, at operation 1030, the processing logic triggers an associated event by setting a corresponding status bit.

If, at operation 1015, the target service application is a proxy service application, at operation 1040, the processing logic calls a request send method of the proxy service application to forward the service request to the target service application on the second core. For example, the FTL service framework 150 can determine that the proxy service application has been registered at the first core for communicating with the second service application executing on the second core. The FTL service framework 150 can then call the request send method of the proxy service application to forward the service request to the second core, causing the second core to handle to the service request by executing the second service application (e.g., see operations 1045-1050).

In some embodiments, the OOB message handler 174 of first core is employed to facilitate this communication. Each core should have the OOB message handler 174 that can receive a special OOB message type of FTL service request and invoke a local service send request, e.g., FilService_SendRequest( ) for a corresponding service application identifier after message decoding. A caller service application can be aware of potential usage of the OOB message handler 174 used under the send request and check for any return errors and retry if the operation fails. In some embodiments, the OOB message handler 174 uses a ping-pong buffer with shared memory, where a service application can read from ping-pong buffer and invoke the FTL service request to the target service application.

At operation 1045, the processing logic (e.g., of the second core) detects receipt of the service request.

At operation 1050, the processing logic (e.g., of the second core) decodes the service request and determines that the target service application is running on the second core. The second core can then perform operations 1020, 1025, and 1030, as performed by the first core when there was no proxy service application.

FIG. 11 is a flow diagram of an example method 1100 of drive frame reset (DFR) flow across a plurality of cores according to some embodiments. The method 1100 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 1100 is performed by the service manager 113 of FIG. 1A. In some embodiments, the method 1100 is performed by the plurality of cores 118 of FIGS. 1A-1B, to include operation of the FTL service framework 150. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Challenges with previous DFR flows include a functionality that needs to go out and reset modules, e.g., 10-30 different modules. Thus, there is a need to know which modules have to talk to perform the drive frame reset. For this, need to know what kind of core, what function needs to make, what data needs to be passed, etc., in order to be able to reset the service. If the service is in another core, then have to send a cross-core message and be prepared to receive a response. As a result, the DFR flow gets very complicated, and each service change or addition further complicates the DFR flow. The method 1100 can therefore be understood as an example of different cores, to include OOB task handlers, sending and receiving messages in order to execute this particular DFR function, e.g., reset services across different cores of the controller 115.

At operation one (“1”), the frontend 404 provides a DFR requirement to an OOB message handler running on the second core. The OOB message handler 174 was discussed with refence to FIG. 1B and be executed at each core.

At operation two (“2”), the OOB task on the second core triggers an event, e.g., in response to receipt of the DFR requirement. In response to the trigger event, the processing logic can perform quiesce (e.g., of the FSM logic) by sending suspend requests to the service applications in a package of cores 118. A status of quiesce can be obtained by sending query service status requests to the cores 118. After, quiesce completes, a series of synchronization requests to target service applications can be sent as follows.

At operation three point one (“3.1”) an event task handler of the second core can send a synchronization request to the first core. The OOB message handler of the first core can respond with a synchronization response.

At operation three point two (“3.2”), the event task handler of the second core can send a synchronization request to the OOB message handler running on the third core. The OOB message handler of the third core can send a synchronization response to the OOB message handler of the second core.

At operation three point three (“3.3”), the event task handler of the second core can send a synchronization request to itself.

At operation four point one (“4.1), the event task handler of the second core sends a reset request to the OOB message handler of the first core. The OOB message handler of the first core can send a reset response to the event task handler of the second core.

At operation three point four (“3.4”), the event task handler of the second core can send a reset request to the third core. The OOB message handler of third core can send a reset response to the OOB message handler of the second core.

At operation four point three (“4.3”), the event task handler of the second core can send a reset request to itself. The event task handler of the second core can send a response to the frontend 404, e.g., indicating that the DFR flow has completed. Of course, additional cores could be added to this DFR method flow, so the illustrated three cores is merely exemplary.

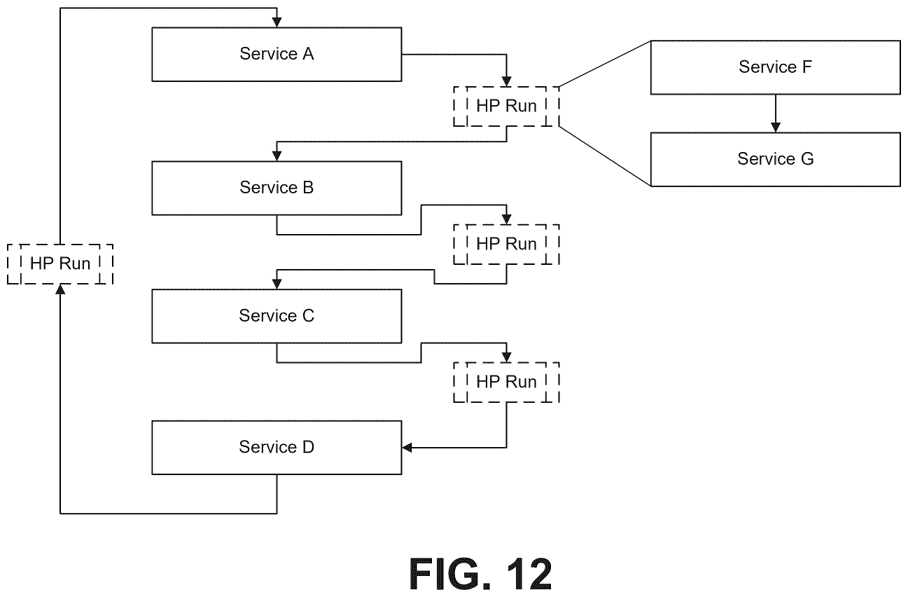

FIG. 12 is an operation block diagram illustrating service priority control of a plurality of service applications according to some embodiments. In embodiments, the FTL service framework 150 schedules a service application of the plurality of service applications to run according to one of the following states based on priority of control. The first can be a disabled state in which the service application is not scheduled to run. The second can be a first priority state in which service application is scheduled to run in cyclical fashion with priority normalized to other service applications, which is illustrated by Service A, Service B, Service C, and Service D. The third can be a second priority state, which has a higher priority than the first priority state, in which the service application is scheduled to run at a higher frequency than service applications in the first priority state. Thus, for example, in between running Service A and Service B, an extra high-priority (HP) run can be performed that includes Service F and Service G, which are in the second priority state. This extra HP run can be performed between any run of the first priority service applications, as illustrated, e.g., between Service B and Service C, between Service C and Service D, and between Service D and Service A. The dashed boxes of the “HP Run” just indicates that at some of the HP Runs are optional, although at least one high-priority run would be expected due to Service F and Service G carrying the second priority state.

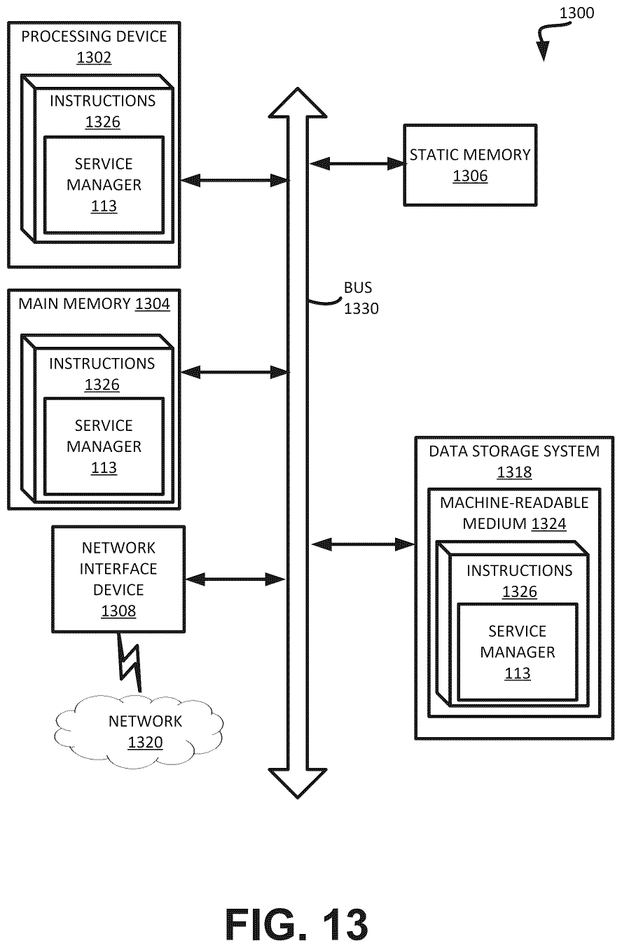

FIG. 13 illustrates an example machine of a computer system 1300 within which a set of instructions, for causing the machine to perform any one or more of the methodologies discussed herein, can be executed. In some embodiments, the computer system 1300 can correspond to a host system (e.g., the host system 120 of FIG. 1A) that includes, is coupled to, or utilizes a memory sub-system (e.g., the memory sub-system 110 of FIG. 1A) or can be used to perform the operations of a controller (e.g., to execute an operating system to perform operations corresponding to the service manager 113 of FIG. 1A). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1300 includes a processing device 1302, a main memory 1304 (e.g., read-only memory (ROM), flash memory, dynamic random access memory (DRAM) such as synchronous DRAM (SDRAM) or Rambus DRAM (RDRAM), etc.), a static memory 1306 (e.g., flash memory, static random access memory (SRAM), etc.), and a data storage system 1318, which communicate with each other via a bus 1330.

Processing device 1302 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1302 can also be one or more special-purpose processing devices such as an application specific integrated circuit (ASIC), a field programmable gate array (FPGA), a digital signal processor (DSP), network processor, or the like. The processing device 1302 is configured to execute instructions 1326 for performing the operations and steps discussed herein. The computer system 1300 can further include a network interface device 1308 to communicate over the network 1320.

The data storage system 1318 can include a machine-readable storage medium 1324 (also known as a computer-readable medium, such as a non-transitory computer-readable medium) on which is stored one or more sets of instructions 1326 or software embodying any one or more of the methodologies or functions described herein. The instructions 1326 can also reside, completely or at least partially, within the main memory 1304 and/or within the processing device 1302 during execution thereof by the computer system 1300, the main memory 1304 and the processing device 1302 also constituting machine-readable storage media. The machine-readable storage medium 1324, data storage system 1318, and/or main memory 1304 can correspond to the memory sub-system 110 of FIG. 1A.

In one embodiment, the instructions 1326 include instructions to implement functionality corresponding to the service manager 113 of FIG. 1A). While the machine-readable storage medium 1324 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A processing device comprising:
a plurality of cores coupled to a memory device that stores data, wherein the plurality of cores are to perform operations comprising executing:
a plurality of service applications that implement at least a portion of a flash translation layer (FTL) to direct operations to be performed by the memory device with reference to the data while tracking translations between a logical block address space to a physical address space; and
an FTL service framework that comprises a plurality of application programming interfaces (APIs), wherein the plurality of APIs are configured to standardize communication between the plurality of service applications across the plurality of cores during runtime operation of the plurality of cores.

2. The processing device of claim 1, wherein the plurality of service applications and the FTL service framework are configured to be being implemented, without modification, on a different plurality of cores implementing a different FTL design architecture.

3. The processing device of claim 1, wherein the plurality of APIs are respectively configured to:
initialize a service directory, which is performed once per core for the plurality of cores;
register a service execution set in the service directory;
register each service application with the service execution set; and
run the service applications as a group that comprises the service execution set.

4. The processing device of claim 3, wherein the service execution set comprises a plurality of service applications of a polling type that are configured to execute continuously to completion except in response to event-based interruptions from event-driven service applications.

5. The processing device of claim 3, wherein the service execution set comprises a plurality of applications of an event-driven type that are configured to execute in response to detecting an FTL-related event, and wherein the operations further comprise associating, with the service execution set, at least one of: a set of events, each of which is associated with a service registered with the service execution set, a set of events for services coordination, or a bitmask to indicate a trigger event bit value associated with each respective service application of the service execution set.

6. The processing device of claim 1, wherein the operations further comprise executing an out-of-bounds (OOB) message handler to handle OOB tasks related to auxiliary communication between the plurality of cores.

7. The processing device of claim 1, wherein the FTL service framework is to perform operations comprising:
registering, with a unique identifier, each service application of the plurality of service applications to a particular core of the plurality of cores; and
inserting each service application into a service directory that is capable of being queried.

8. The processing device of claim 7, wherein the plurality of APIs are respectively configured to reference the service directory to perform at least one of:
find a service application using a service identifier;
send a service request to another service application to request a particular action be performed;
clear a service request after having performed the particular action;
retrieve a service request received from another service application;
set a status of an associated service application;
determine a status of the associated service application;
query a status of another service application;
register the associated service locally on a particular core; or
register a proxy service application to communicate with a related service application running on a different core.

9. A system comprising:
a memory device to store data; and
a plurality of cores coupled to the memory device, wherein the plurality of cores are to perform operations comprising executing:
a plurality of service applications that implement at least a portion of a flash translation layer (FTL) to direct operations to be performed by the memory device with reference to the data while tracking translations between a logical block address space to a physical address space; and
an FTL service framework that comprises a plurality of application programming interfaces (APIs), wherein the plurality of APIs are configured to standardize communication between the plurality of service applications across the plurality of cores during runtime operation of the plurality of cores.

10. The system of claim 9, wherein at least a first API of the plurality of APIs is configured to send a service request from a first service application to a second service application to request a particular action be performed by the second service application.

11. The system of claim 10, wherein the service request is a common service request selected from a group of service request types comprising at least two of:
a work request notifying the second service application of the particular action;
a synchronization request prompting the second service application to synchronize and flush data associated with the second service application;
a suspension request prompting the second service application to suspend service;
an activate request prompting the second service application to activate service;
a reset request prompting the second service application to reset service;
a persist request prompting the second service application to store internal data to a particular memory location;
a restore request prompting the second service application to restore service; or
a response from a request prompting the second service application to transmit a response to a previously received service request.

12. The system of claim 9, wherein the operations further comprise maintaining, in the memory device, one or more doublewords of bits indicating one or more statuses associated with each service application of the plurality of service applications, wherein a first subset of the one or more doublewords are predefined and a second subset of the one or more doublewords are service-specific statuses.

13. The system of claim 12, wherein the operations further comprise at least one of:
for a block stripe retirement service application, updating a customized service bit of the one of more doublewords to indicate whether there is a pending block to be retired;
for a folding service application, reporting a current folding victim block; or
for a write service application, using particular bits of the one or more doublewords to report a remaining free space of cursor locations.

14. A method comprising:
executing, by a plurality of cores of a processing device, a plurality of service applications that implement at least a portion of a flash translation layer (FTL) to direct operations to be performed by a memory device while tracking translations between a logical block address space to a physical address space; and
executing, by the plurality of cores, an FTL service framework that comprises a plurality of application programming interfaces (APIs), wherein the plurality of APIs are configured to standardize communication between the plurality of service applications across the plurality of cores during runtime operation of the plurality of cores.

15. The method of claim 14, further comprising scheduling a service application of the plurality of service applications to run according to one of the following states based on priority of control:
a disabled state in which the service application is not scheduled to run;
a first priority state in which service application is scheduled to run in cyclical fashion with priority normalized to other service applications; and
a second priority state, which has a higher priority than the first priority state, in which the service application is scheduled to run at a higher frequency than service applications in the first priority state.

16. The method of claim 14, further comprising:
registering, with a unique identifier, each service application of the plurality of service applications to a particular core of the plurality of cores;
reporting, via updates to state bits stored in the memory device that provide a common status, a service state for each service application; and
for each service application, at least one of:
updating, directly after the registering, the state bits to reflect a pre-initialization state;
updating the state bits to reflect an initialization state;
in response to the service application having no on-going data processing, updating the state bits to reflect an idle state; or
in response to the service application undergoing data processing, updating the state bits to reflect an active state.

17. The method of claim 16, further comprising:
transmitting, by a first service application to a second service application, a suspend flow service request that includes a suspend reason;
saving, by the second service application, the suspend reason;
performing, by the second service application, one or more actions to complete ongoing work;
updating, by the second service application, the state bits to reflect an idle state;
transmitting, by the first service application to the second service application, an activate service request that includes an activation reason;
saving, by the second service application, the activation reason while clearing the suspend reason; and
retaining, by the second service application, the state bits reflecting the idle state.

18. The method of claim 16, further comprising:
transmitting, by a first service application to a second service application, a reset service request;
resetting, by the second service application, internal data associated with the second service application to an initialized state; and
updating, by the second service application, the state bits to reflect an initialization state.

19. The method of claim 16, further comprising:
transmitting, by a first service application to a second service application, a synchronization service request;
recording, by the second service application, a synchronization request type field in the state bits;
performing, by the second service application, one or more synchronization and flush operation associated with the synchronization service request; and
updating, by the second service application, the state bits to reflect an idle state and synchronization status.

20. The method of claim 16, further comprising:
determining, by a first service application running on a first core of the plurality of cores, a need to transmit service requests to or query statuses of a second service application running on a second core of the plurality of cores;
determining, by the FTL service framework, that a proxy service application has been registered at the first core for communicating with the second service application executing on the second core; and
calling, by the FTL service framework, a request send method of the proxy service application to forward a service request to the second core, causing the second core to handle to the service request by executing the second service application.
